(19) United States
(12) Patent Application Publication
(10) Pub. No.: US 2004/0263978 A1
(43) Pub. Date: Dec. 30, 2004

(54) METHOD AND APPARATUS FOR FORMING AN IMAGE USING ONLY DIFFRACTIVE OPTICS

(76) Inventor: Robert B. Chipper, Allen, TX (US)

Correspondence Address: T. Murray Smith, Esq., Baker Botts L.L.P., Suite 600, 2001 Ross Avenue, Dallas, TX, 75201-2980, US

(21) Appl. No.: 10/464,970

(22) Filed: Jun. 18, 2003

(51) Int. Cl. G02B 5/18

(52) U.S. Cl. 359/566

(57) ABSTRACT

A method includes configuring an imaging lens section to be free of structure with optically refractive power and to have a lens with an optically diffractive characteristic, and passing radiation from a scene through the imaging lens section, the imaging lens section causing the radiation to form an image at an image plane. An apparatus includes an imaging lens section which is responsive to radiation from a scene for causing the radiation to form an image at an image plane, the imaging lens section being free of structure with optically refractive power and including a lens which has an optically diffractive characteristic.

### TECHNICAL FIELD OF THE INVENTION

This invention relates in general to optical systems and, more particularly, to optical systems which form an image in response to incident radiation.

### BACKGROUND OF THE INVENTION

There are a variety of optical systems which can form an image in response to incident radiation. Some of these optical systems are specifically configured to image infrared radiation. In recent years, there has been a decrease in the cost of optical systems which image infrared radiation. Nevertheless, the current cost of infrared imaging optical assemblies is still too high to permit wide use of these assemblies in high volume, low cost markets such as the automotive industry, where competitive price pressures are very strong.

Some of the techniques which have been used in recent years to reduce the cost of infrared imaging lens assemblies have included replacement of some (but not all) refractive lenses with diffractive lenses, in order to eliminate costly refractive elements. Further, proper material selection for some elements, such as use of an appropriate infrared glass, has permitted the formation of lenses using some high volume manufacturing processes, such as molding or casting, thereby reducing fabrication costs. The result has been infrared imaging lens assemblies which contain a combination of refractive optics and diffractive optics. While systems of this type have been generally adequate for their intended purposes, they have not been satisfactory in all respects.

### SUMMARY OF THE INVENTION

From the foregoing, it may be appreciated that a need has arisen for a method and apparatus which can image radiation, and which can be easily manufactured at low cost and in large volumes. One form of the invention involves an apparatus having an imaging lens section which is responsive to radiation from a scene for causing the radiation to form an image at an image plane, the imaging lens section being free of structure with optically refractive power and including a lens which has an optically diffractive characteristic.

Another form of the invention involves a method which includes configuring an imaging lens section to be free of structure with optically refractive power and to have a lens with an optically diffractive characteristic, and passing radiation from a scene through the imaging lens section, the imaging lens section causing the radiation to form an image at an image plane.

### BRIEF DESCRIPTION OF THE DRAWINGS

A better understanding of the present invention will be realized from the detailed description which follows, taken in conjunction with the accompanying drawings, in which:

FIG. 1 is a diagram of a lens assembly which images infrared radiation using only diffractive optics, and which embodies aspects of the present invention; and

FIG. 2 is a graph showing a nominal modulation transfer function for the lens assembly of FIG. 1 as a function of fractional bandwidth.

### DETAILED DESCRIPTION

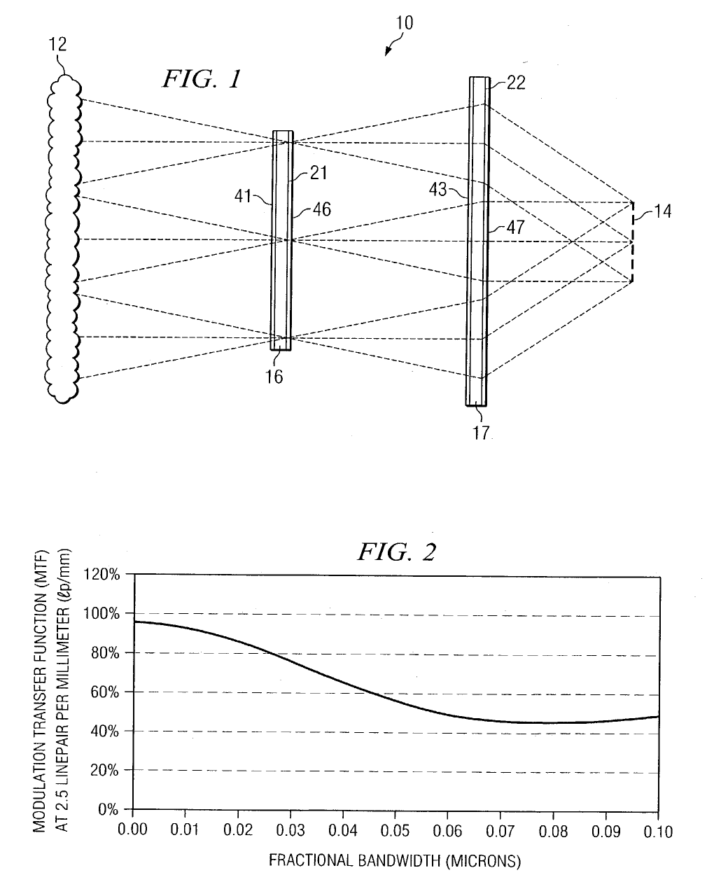

FIG. 1 is a diagrammatic view of a lens assembly 10 which embodies aspects of the present invention. As discussed below, the lens assembly 10 does not have any structure which is capable of refracting radiation, but instead uses only diffractive structure to effect imaging of radiation.

The lens assembly 10 receives infrared radiation emitted by a scene which is shown diagrammatically at 12, and influences this radiation in a manner so that it forms at an image 14 at an image plane. The disclosed embodiment is configured to effect imaging of far infrared radiation having wavelengths in a waveband of 8 to 14 microns. However, the present invention is not limited to this particular waveband, and could alternatively be used to effect imaging of near infrared radiation having wavelengths in a waveband of approximately 3 to 5 microns, or narrowband radiation in some other portion of the optical spectrum, including but not limited to visible radiation.

The lens assembly 10 includes two lenses in the form of lens elements 16 and 17. In the disclosed embodiment, the lens elements 16 and 17 are each made from silicon. However, they could alternatively be made of any other suitable material, including but not limited to an infrared polymer, or a combination of silicon and an infrared polymer. As discussed above, the disclosed embodiment is configured to effect imaging of radiation in the far infrared waveband, but could be adapted for use in other wavebands. It will be recognized that the particular material used for each lens element will depend on the particular waveband within which that element is being used.

The side of each lens element 16 or 17 nearest the scene 12 is referred to herein as the first or front surface thereof, and the opposite side of each lens element 16 or 17 is referred to herein as the second or rear surface thereof. The lens element 16 has a diffractive surface 21 on the rear side thereof, and the lens element 17 has a diffractive surface 22 on the rear side thereof.

As explained above, the lens elements 16 and 17 in the disclosed embodiment are made from silicon. The diffractive surface 21 or 22 on the rear side of each lens element 16 or 17 is formed by etching the material of the lens element, or alternatively by embossing the material of the lens element. Etching and embossing techniques suitable for forming the diffractive surfaces 21 and 22 are known in the art, and are therefore not described here in detail. The formation of diffractive surfaces through the use of etching or embossing techniques permits each of the lens elements 16 and 17 to be accurately and efficiently manufactured at low cost and in large volumes.

A diamond-like carbon (DLC) coating 41 is provided on the front side of the lens element 16. Suitable DLC coating materials are well known in the art. In the disclosed embodiment, the DLC coating 41 is a multi-layer coating of a type known in the art, and is therefore not described here in detail. The DLC coating 41 is a hard coating that protects the lens element 16 from scratching or other damage due to the external environment. By providing the coating 41 on the lens element 16, it is not necessary for the lens assembly 10 to have a separate protective non-imaging window element disposed between the scene 12 and the lens element 16, thereby reducing the overall cost of the lens assembly 10.

A bandpass filter coating 43 is provided on the front surface of the lens element 17. The bandpass filter coating 43 serves as a narrow pass filter which rejects radiation other than radiation in the specific wavebend of interest, which in the disclosed embodiment is 8 to 14 microns. The bandpass filter coating 43 actually includes a number of separate layers, but they are not separately illustrated because the structure of the filter coating 43 is technology known in the art.

Anti-reflective (AR) coatings 46 and 47 of a known type are provided on each of the rear surfaces 21 and 22 of the lens elements 16 and 17, which are the diffractive surfaces. The AR coatings 46 and 47 help to reduce the loss of energy which would otherwise occur as a result of undesirable reflections if these surfaces were left uncoated. In particular, the AR coatings reduce the Fresnel reflection losses and raise the transmittance of the lens elements 16 and 17. In the disclosed embodiment, the AR coatings 46 and 47 are each a single-layer coating of a known type, but it would alternatively be possible to use a multi-layer AR coating.

Some specific characteristics of the lens assembly 10 are set forth in TABLE 1. In TABLE 1, the length dimension refers to the distance from the DLC coating 41 to the image 14. The fractional bandwidth of operation within the wavelength range of operation is defined by the formula:

(λ1−λ2)/((λ1+λ2)/2).

For example, where the wavelength range of operation is from 8 microns to 14 microns, λ1 in this formula would be 14 microns, and λ2 would be 8 microns.

TABLE 1
CHARACTERISTICS

| | |
|---|---|
| Field of View | 25 degrees |
| Effective Focal Length | 23 mm |
| F/Number | F/1 |
| Total Number of Elements | 2 |
| Flat Surfaces | 4 |
| Diffractive Surfaces | 2 |
| Aspheric Surfaces | 0 |
| Substrate Material | Silicon |
| Length | 1.75 inches |
| Fractional Bandwidth | 0.2 microns |
| Wavelength Range of Operation | 8-14 microns |

Some basic parameters of the lens elements 16 and 17 are set forth in TABLE 2, where R1 refers to the first or front surface encountered by radiation reaching a lens, and R2 means the second or rear surface encountered by the radiation.

TABLE 2
Parameters

| | | Index | | | | Diffractive |
|---|---|---|---|---|---|---|
| | | at | Surface | | Diffractive | Parameters |
| Lens | Material | 10 μm | Type | Radii | Surface | (R2) |
| 16 | Si | 3.42 | R1 = Sphere/ | R1 = Infinity | R1 No | C1 = 0.057982 |
| | | | Flat | | | C2 = −0.151640 |
| | | | R2 = Diffractive | R2 = Infinity | R2 Yes | C3 = −0.097673 |
| | | | | | | C4 = −0.50003 |
| | | | | | | C5 = −0.116280 |
| 17 | Si | 3.42 | R1 = Sphere/ | R1 = Infinity | R1 No | C1 = 0.561890 |
| | | | Flat | | | C2 = −0.003646 |
| | | | R2 = Diffractive | R2 = Infinity | R2 Yes | C3 = 0.019104 |
| | | | | | | C4 = −0.042072 |
| | | | | | | C5 = 0.031824 |

Exact lens parameters for the lens elements 16 and 17 of the disclosed embodiments are set forth in TABLE 3, including radii, centered thickness, air gaps, aspheric coefficients and diffractive surface parameters. The information in TABLE 3 is set forth in a format suitable as input for an optical design software program, such as the program which is commercially available under the trademark CodeV® from Optical Research Associates of Pasadena, Calif.

TABLE 3
CODE V > lis
23 mm/10 mm format f/1 All-Si

| | RDY | THI | RMD | | GLA |
|---|---|---|---|---|---|
| >OBJ: | INFINITY | INFINITY | | | |
| 1: | INFINITY | 0.000000 | | | |
| 2: | INFINITY | 0.000000 | | | |
| 3: | INFINITY | 0.500000 | | | |
| 4: | INFINITY | 0.060000 | | ‘si’ | |
| 5: | INFINITY | 0.005000 | | | |

| | | | | | |
|---|---|---|---|---|---|
| HOE: | | | | | |
| HV1: | REA | HV2: | REA | HOR: | −1 |
| HX1: | 0.000000E+00 | HY1: | 0.000000E+00 | HZ1: | 0.713927E+18 |
| CX1: | 100 | CY1: | 100 | CZ1: | 100 |
| HX2: | 0.000000E+00 | HY2: | 0.000000E+00 | HZ2: | 0.713927E+18 |
| CX2: | 100 | CY2: | 100 | CZ2: | 100 |
| HWL: | 10200.00 | HTO: | SPH | HCT: | R |
| HCO/HCC | | | | | |
| C1: | 5.7982E−02 | C2: | −1.5164E−01 | C3: | −9.7673E−02 |
| C1 | 0 | C2: | 0 | C3: | 0 |
| C4: | −5.0003E−02 | C5 | −1.1628E−01 | | |
| C4 | 0 | C5: | 0 | | |

| | | | |
|---|---|---|---|
| STO: | INFINITY | 0.878923 | |
| 7: | INFINITY | 0.010000 | ‘si’ |
| 8: | INFINITY | 0.814195 | |

| | | | | | |
|---|---|---|---|---|---|
| HOE: | | | | | |
| HV1: | REA | HV2: | REA | HOR: | −1 |
| HX1: | 0.000000E+00 | HY1: | 0.000000E+00 | HZ1: | 0.713927E+18 |
| CX1: | 100 | CY1: | 100 | CZ1: | 100 |
| HX2: | 0.000000E+00 | HY2: | 0.000000E+00 | HZ2: | 0.713927E+18 |
| CX2: | 100 | CY2: | 100 | CZ2: | 100 |
| HWL: | 10200.00 | HTO: | SPH | HCT: | R |
| HCO/HCC | | | | | |
| C1: | 5.6189E−01 | C2: | −3.6460E−03 | C3: | 1.9104E−02 |
| C1: | 0 | C2: | 0 | C3: | 0 |
| C4: | −4.2072E−02 | C5: | 3.1824E−02 | C3: | 0 |
| C4: | 0 | C5: | 0 | | |

| | | |
|---|---|---|
| 9: | INFINITY | 0.000000 |
| 10: | INFINITY | 0.000000 |
| IMG: | INFINITY | 0.000000 |

SPECIFICATION DATA

| | | | |
|---|---|---|---|
| FNO | 1.00000 | | |
| DIM | IN | | |
| WL | 11000.00 | 10000.00 | 9000.00 |
| REF | 2 | | |
| WTW | 1 | 2 | 1 |
| INI | rbc | | |
| XRI | 0.00000 | 0.00000 | 0.00000 |
| YRI | 0.00000 | 0.20000 | −0.20000 |
| WTF | 1.00000 | 1.00000 | 1.00000 |
| VUX | 0.00000 | 0.00000 | 0.00000 |
| VLX | 0.00000 | 0.00000 | 0.00000 |
| VUY | 0.00000 | 0.00000 | 0.00000 |
| VLY | 0.00000 | 0.00000 | 0.00000 |

PRIVATE CATALOG

| | | | | | | |
|---|---|---|---|---|---|---|
| PWL | 12000.00 | 10000.00 | 8000.00 | 5000.00 | 4000.00 | 3000.00 |
| ‘si’ | 3.417223 | 3.417740 | 3.418400 | 3.422100 | 3.425390 | 3.432390 |

REFRACTIVE INDICES

| | | | |
|---|---|---|---|
| GLASS CODE | 11000.00 | 10000.00 | 9000.00 |
| ‘Si’ | 3.417467 | 3.417740 | 3.418049 |

No solves defined in system
No pickups defined in system
This is a decentered system. If elements with power are
decentered or tilted, the first order properties are probably
inadequate in describing the system characteristics.

INFINITE CONJUGATES

| | |
|---|---|
| EEL | 0.9055 |
| BFL | 0.0000 |
| FFL | 0.9988 |
| FNO | 1.0000 |
| IMG DIS | 0.0000 |
| OAL | 2.7701 |

PARAXIAL IMAGE

| | |
|---|---|
| HT | 0.2044 |
| ANG | 12.7230 |

ENTRANCE PUPIL

| | |
|---|---|
| DIA | 0.9055 |
| THI | 1.0246 |

EXIT PUPIL

| | |
|---|---|
| DIA | 31.8389 |
| THI | −31.8389 |

CODE V > out t

In the embodiment of FIG. 1, the diffractive surface 46 of lens 16 has as its primary purpose the correction of pupil aberrations, one example of which is spherical aberrations. The diffractive surface 47 on lens 17 has as its primary function the focusing of infrared energy so that the energy forms an image 14 at the image plane, and has as its secondary function the correction of field aberrations. Alternatively, however, it would be possible for the diffractive structure to collectively perform a larger or smaller number of functions, and for the functions to be allocated differently among one or more diffractive surfaces. The configuration of FIG. 1 provides a highly corrected and good quality image with a very high modulation transfer function (MTF) for a particular wavelength, where the MTF will decrease as the fractional bandwidth increases.

In this regard, FIG. 2 is a graph showing a nominal modulation transfer function (MTF) for the lens assembly of FIG. 1, as a function of fractional bandwidth. In general, the wider the bandwidth of the radiation imaged by the lens assembly 10, for example as determined by the bandwidth of the bandpass filter coating 43, the lower the MTF, which is a measure of the contrast of the lens assembly.

As discussed above, the lens elements 16 and 17 of the disclosed embodiment are made of silicon, but could alternatively be made of an infrared polymer of a type known in the art. The polymer lens elements could have AR coatings of the type discussed above. However, polymer lens elements have relatively low reflectance and relatively high transmittance even without AR coatings, and the AR coatings could therefore be optionally omitted. Polymer lens elements could optionally be made relatively thin, for example on the order of approximately 0.002 inch. In that event, a non-imaging window could be provided between the scene and the lens elements, in order to provide protection for the lens elements. The window could, for example, be silicon or germanium, with a DLC coating on the front or outer side and an AR coating on the rear or inner side. A further window could be provided on the opposite side of the lens elements, for example in the region of the image plane, and could have the bandpass filter coating thereon. Alternatively, the AR coating could be omitted and the bandpass filter coating could be provided on the rear or inner side of the outer window.

The invention provides a number of advantages. One such advantage is that, through the careful selection and combination of lens materials, spectral band, diffractive surfaces and performance requirements, an imaging lens assembly is provided which can produce an image using only diffractive optical elements, and without using any refractive optical surfaces with power. As a related advantage, the use of only diffractive surfaces which are approximately flat permits the diffractive surfaces to be fabricated using traditional, high volume, low cost processes, such as etching or embossing. Consequently, the imaging lens assembly can be manufactured at a very low cost. In fact, by using very inexpensive materials and processes, suitable performance can be achieved while reducing the manufacturing cost by a factor of ten times or more in relation to pre-existing lens systems.

The invention is advantageous when used to implement an imaging lens assembly intended for use in imaging infrared radiation. As a result, an imaging lens assembly which embodies the invention can be very advantageous in markets where high volume and low cost are important due to competitive pricing pressures, one example of which is an infrared imaging system intended for nighttime use in a vehicle. The invention is also advantageous for other military and commercial uses where a reasonable level of performance is needed at a relatively low cost, including surveillance applications.

Although one embodiment has been illustrated and described in detail, it will be understood that various substitutions and alterations are possible without departing from the spirit and scope of the present invention, as defined by the following claims.

1. An apparatus comprising an imaging lens section which is responsive to radiation from a scene for causing said radiation to form an image at an image plane, said imaging lens section being free of structure with optically refractive power and including a lens which has an optically diffractive characteristic, said imaging lens section including a further lens which has an optically diffractive characteristic, at least one of said lenses being made from a combination of silicon and an infrared polymer.

2. An apparatus according to claim 1, wherein said imaging lens section is configured to form said image using radiation within a relatively narrow waveband.

3. An apparatus according to claim 1, wherein said imaging lens section is configured to form said image using infrared radiation.

4. (Cancelled)

5. An apparatus according to claim 1, wherein each said lens has a diffractive surface on one side thereof.

6. An apparatus according to claim 5, wherein at least one of said diffractive surfaces is one of an etched surface and an embossed surface.

7. An apparatus according to claim 5, wherein said each said diffractive surface is one of an etched surface and an embossed surface.

8. An apparatus according to claim 1, wherein said diffractive characteristic of one said lens effects correction of pupil aberrations, and said diffractive characteristic of the other said lens effects focusing of said radiation and correction of field aberrations.

9. An apparatus according to claim 1, wherein each said lens is made from a material transmissive to infrared radiation having wavelengths in a range of approximately 3 to 5 microns.

10. An apparatus according to claim 1, wherein each said lens is made from a material transmissive to infrared radiation having wavelengths in a range of approximately 8 to 14 microns.

11. (Cancelled)

12. (Cancelled)

13. (Cancelled)

14. An apparatus according to claim 1, wherein said lens has on at least one side thereof a coating that effects bandpass filtering of said radiation.

15. An apparatus according to claim 1, including an uncooled infrared detector disposed in the region of said image plane.

16. A method, comprising:
configuring an imaging lens section to be free of structure with optically refractive power and to have a lens with an optically diffractive characteristic by:
configuring said imaging lens section to include a further lens which has an optically diffractive characteristic; and
making at least one of said lenses from a combination of silicon and an infrared polymer; and
passing radiation from a scene through said imaging lens section, said imaging lens section causing said radiation to form an image at an image plane.

17. A method according to claim 16, wherein said configuring of said imaging lens section includes configuring said imaging lens section to effect said imaging using radiation within a relatively narrow waveband.

18. A method according to claim 16, wherein said configuring of said imaging lens section includes configuring said imaging lens section to effect said imaging using infrared radiation.

19. (Cancelled)

20. A method according to claim 16, wherein said configuring of said imaging lens section includes configuring each said lens to have a diffractive surface on one side thereof.

21. A method according to claim 20, wherein said configuring of said imaging lens section includes forming at least one of said diffractive surfaces by carrying out one of an etching procedure and an embossing procedure.

22. A method according to claim 20, wherein said configuring of said imaging lens section includes forming each of said diffractive surfaces by carrying out one of an etching procedure and an embossing procedure.

23. A method according to claim 16, wherein said configuring of said imaging lens section includes selecting said diffractive characteristic of one said lens to effect correction of pupil aberrations, and selecting said diffractive characteristic of the other said lens to effect focusing of said radiation and correction of field aberrations.

24. A method according to claim 16, wherein said configuring of said imaging lens section includes making each said lens from a material which is transmissive to infrared radiation having wavelengths in a range of approximately 3 to 5 microns.

25. A method according to claim 16, wherein said configuring of said imaging lens section includes making each said lens from a material which is transmissive to infrared radiation having wavelengths in a range of approximately 8 to 14 microns.

26. (Cancelled)

27. (Cancelled)

28. A method according to claim 16, wherein said configuring of said imaging lens assembly includes coating at least one side of said lens with a material that effects bandpass filtering of said radiation.

29. A method according to claim 16, including detecting said image by using an uncooled infrared detector disposed in the region of said image plane.

30. An apparatus for forming an image, comprising:
a first diffractive lens operable to:
receive radiation from a scene; and
diffract the radiation received from the scene, the first diffractive lens being free of structure with optically refractive power, the first diffractive lens having an optically diffractive characteristic, the first diffractive lens having a first diffractive surface; and
a second diffractive lens operable to:
receive the radiation from the first diffractive lens;
diffract the radiation received from the first diffractive lens; and
form an image of the scene at an image plane, the second diffractive lens being free of structure with optically refractive power, the second diffractive lens having an optically diffractive characteristic, the second diffractive lens having a second diffractive surface.

31. The apparatus according to claim 30, wherein the diffractive lenses comprise at least one of silicon, germanium, an infrared polymer, and an infrared glass.

32. The apparatus according to claim 30, wherein at least one of the diffractive surfaces comprises one of an etched surface and an embossed surface.

33. The apparatus according to claim 30, wherein:
the diffractive characteristic of one of the diffractive lenses is operable to reduce the effect of a pupil aberration; and
the diffractive characteristic of the other of the diffractive lenses is operable to focus the radiation.

34. The apparatus according to claim 30, wherein at least one of the diffractive lenses has a coating operable to:
transmit a narrow band of frequencies of the radiation; and
reject the other frequencies of the radiation.

35. The apparatus according to claim 30, wherein the radiation comprises infrared radiation.

36. The apparatus according to claim 30, further comprising an uncooled infrared detector disposed in the region of the image plane.

37. A method for forming an image, comprising:
receiving at a first diffractive lens radiation from a scene, the first diffractive lens being free of structure with optically refractive power, the first diffractive lens having an optically diffractive characteristic, the first diffractive lens having a first diffractive surface;
diffracting the radiation received from the scene;
receiving at a second diffractive lens the radiation from the first diffractive lens, the second diffractive lens being free of structure with optically refractive power, the second diffractive lens having an optically diffractive characteristic, the second diffractive lens having a second diffractive surface;
diffracting the radiation received from the first diffractive lens;
forming an image of the scene at an image plane.

38. The method according to claim 37, wherein the diffractive lenses comprise at least one of silicon, germanium, an infrared polymer, and an infrared glass.

39. The method according to claim 37, wherein at least one of the diffractive surfaces comprises one of an etched surface and an embossed surface.

40. The method according to claim 37, further comprising:
reducing the effect of a pupil aberration using the diffractive characteristic of one of the diffractive lenses; and
focusing the radiation using the diffractive characteristic of the other of the diffractive lenses.

41. The method according to claim 37, further comprising performing the following with a coating of at least one of the diffractive lenses:
transmitting a narrow band of frequencies of the radiation; and
rejecting the other frequencies of the radiation.

42. The method according to claim 37, wherein the radiation comprises infrared radiation.

43. The method according to claim 37, further comprising detecting the radiation at an uncooled infrared detector disposed in the region of the image plane.
